(19) United States
(12) Patent Application Publication
(10) Pub. No.: US 2026/0252423 A1
(43) Pub. Date: Aug. 27, 2026

(54) INTER-APPLICATION COMMUNICATION IN BROWSER-BASED APPLICATION DEPLOYMENT CLUSTER

(71) Applicant: International Business Machines Corporation, Armonk, NY (US)

(72) Inventors: Paritosh RANJAN, Kolkata (IN); SARIKA SINHA, Bangalore (IN); Prodip ROY, Kolkata (IN); Bhubaneswar PADHAN, Kolkata (IN)

(21) Appl. No.: 19/060,658

(22) Filed: Feb. 22, 2025

(51) Int. Cl. G06F 9/54; G06F 8/60

(52) U.S. Cl. CPC G06F 9/547; G06F 8/60

(57) ABSTRACT

Inter-application communication in a browser-based application deployment cluster (BADC) includes receiving a request to access a first microservice associated with a first application. The BADC is associated with a web-browser application installed on a computer system. The request may be received from a second microservice associated with a second application, via the web-browser application. The second microservice is present in the BADC. The operations include determining presence or absence of the first microservice associated with the first application in the BADC, upon receiving the request to access the first microservice. The operations include transmitting the request to the first microservice in the BADC in case the presence of the first microservice in the BADC is determined.

### BACKGROUND

The disclosure relates generally to the field of containerization, more particularly, to communication between containerized applications.

A cluster may be construed as a group of hosts (that may be physical or virtual computing machines) that run containerized applications in an efficient, automated, distributed, and scalable manner. Application containerization is used for deploying and running applications in isolated environments of the applications. A container is an executable package of software that contains elements to run an application in any environment, such as application code and dependencies such as binary code, libraries, and configuration files for easy deployment across different computing environments.

Further, the applications are often developed using microservice architecture which is an approach for developing an application as a collection of independent microservices that communicate with other microservices over a network. Microservices communicate with other microservices in a network to send data (for example, requests, responses, etc.) from one location to another in the network. The communication between microservices experiences some delays due to various reasons, for example, network hops, server performance, high amount of calls, etc. These delays are referred to as latency or network latency. Networks with a longer delay or lag have high latency, while those with fast response times have low latency. Some critical applications rely on low network latency to keep up with their computation demands. Also, high network latencies cause the application performance to degrade. Reducing the number of application calls and/or network hopping reduces latency in communication between microservices thereby enhancing the overall performance of the system.

### SUMMARY

In various embodiments of the disclosure, a computer-implemented method for inter-application communication in a browser-based application deployment cluster is provided. The computer-implemented method includes receiving, by a computer, a first request to access a first microservice associated with a first application. The first request is received from a web-browser application installed on the computer. The computer-implemented method further includes determining, by the computer, a presence or an absence of the first microservice associated with the first application in a browser-based application deployment cluster associated with the web-browser application. The presence or the absence of the first microservice is determined based on the first request. The computer-implemented method further includes transmitting, by the computer, the first request to the first microservice based on the presence of the first microservice in the browser-based application deployment cluster.

In various embodiments of the disclosure, a computer system for inter-application communication in a browser-based application deployment cluster is provided. The computer system includes a processor set, one or more computer-readable storage media, and program instructions stored on the one or more computer-readable storage media. The program instructions are executable by the processor set to cause the processor set to receive a first request to access a first microservice associated with a first application. The first request is received from a second microservice associated with a second application. The second microservice is present in a browser-based application deployment cluster associated with a web-browser application installed on the computer system. The program instructions further cause the processor set to determine a presence of the first microservice associated with the first application in the browser-based application deployment cluster associated with the web-browser application. The presence of the first microservice is determined based on the received first request. The program instructions further cause the processor set to transmit the first request to the first microservice based on the determined presence of the first microservice in the browser-based application deployment cluster.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for inter-application communication in a browser-based application deployment cluster, in accordance with various embodiments of the disclosure;

FIG. 2 is a diagram that illustrates an environment for inter-application communication in a browser-based application deployment cluster, in accordance with various embodiments of the disclosure;

FIG. 3 is a diagram that illustrates exemplary operations for inter-application communication in a browser-based application deployment cluster, in accordance with various embodiments of the disclosure;

FIG. 4 is a diagram that illustrates exemplary operations for deploying a microservice in a browser-based application deployment cluster, in accordance with various embodiments of the disclosure;

FIG. 5 is a diagram that illustrates exemplary components of a system for inter-application communication in a browser-based application deployment cluster, in accordance with various embodiments of the disclosure;

FIGS. 6A – 6C are diagrams that collectively illustrate an exemplary flowchart of a method for inter-application communication in a browser-based application deployment cluster, in accordance with various embodiments of the disclosure;

FIG. 7 is a diagram that illustrates a flowchart for routing a request for accessing a microservice in a browser-based application deployment cluster, in accordance with various embodiments of the disclosure; and

FIG. 8 is a diagram that illustrates a flowchart for inter-application communication in a browser-based application deployment cluster, in accordance with various embodiments of the disclosure.

### DETAILED DESCRIPTION

Computer applications, for performing various operations related to data processing, need resources for handling data. The resources for handling the data for an application are referred to as data processing requirements. The resources include, but are not limited to, computation units (responsible for processing tasks and carrying out various operations of an application like data filtering, data analysis, data routing, etc. for the application), storage units (responsible for storing data that is, for example, downloaded or used by the application), and networking units (responsible for providing access to remote systems, routing of data, management of servers, etc.). For serving the data processing requirements, the computation units often include more than a single computation unit.

Application containerization is a virtualization technology that works at the operating system (OS) level. The application containerization is used for deploying and running distributed applications in isolated environments of the applications, without the use of virtual machines (VMs). A container is a standardized executable package of software that includes everything needed to run an application—such as the application code, libraries, binaries, and configuration files—allowing the application to be deployed consistently across different computing environments. Thus, the containers virtualize the operating system and run anywhere, from a private data center to the public cloud or on a user’s laptop. The containerization of applications provides, including but not limited to, isolation, portability, scalability, efficiency, faster delivery, improved security, easier management, and flexibility to applications. Isolation ensures that applications and their dependencies are encapsulated. The encapsulation of applications and their dependencies prevents conflicts between different components and eases the management of dependencies. Portability is the ability to run containerized applications in any computing environment as the container bundles dependencies of the microservice. Scalability is performed by adding more instances/resources of the container for serving dynamic requirements. Efficiency is in terms of optimized usage of available resources (that is, the available resources are not overused or underused, the available resources can perform operations that the available resources are assigned with) with minimization of overheads. Fast delivery refers to implementing changes/upgrades to the applications to microservices (and not completing applications at once) thereby minimizing downtime and managing the upgrades efficiently. Further, as containers are isolated from one another, if the security of one container is compromised, other containers remain secure, which improves security. Easier management can be achieved by using automation tools for resource management as each container can be allocated a set amount of compute processing unit (CPU) and random access memory (RAM) to handle its tasks. Further, containerization of applications provides flexibility as the components of the applications can be hosted among the physical, virtual, and/or cloud computing environments.

Containers contain the components for the application to function, ensuring consistent behaviour independent of the infrastructure, thus making the applications portable across various operational environments. Further, applications that are containerized can be readily scaled up or down in response to demand, and the management of the containerized applications can be automated by orchestration platforms, which can dynamically scale by adding or deleting containers in response to resource utilization and traffic patterns. Also, containers have less overhead because they only include application-specific libraries and dependencies and share the host operating system's kernel adding to increased efficiency. By enabling developers to combine each service as an independent container, containerization enhances the microservices architectural pattern. Building and maintaining complex distributed systems is made simpler by using containerization. Also, containerization eases modularisation, independent development, deployment, and scaling of individual services.

A microservice is an architecture that separates parts of an application into small, self-containing services (these are the APIs). The microservice architecture is a cloud-native architectural approach in which a single software application is composed of multiple independently deployable components or services. Microservices use application programming interfaces (APIs) that communicate with other APIs in a network for sending data (for example, requests, responses, etc.) from one device to another device in the network. Each microservice may be hosted on a server (or node, or host). Clustering is a technique used in web hosting to improve system performance and reliability by grouping multiple servers. A cluster is a set of nodes (or hosts) associated with a specific containerized deployment. A node (or host) can be a virtual machine or a physical machine. Thus, the cluster is construed as a set of nodes that run containerized applications in an efficient, automated, distributed, and scalable manner. Similarly, a web cluster is a system made up of multiple servers that work in a coordinated way to offer a scalable and reliable web service.

Various microservices interact with other microservices via APIs that exchange requests and responses for performing operations. The exchange of requests and responses between APIs and microservices is an exchange of data that is transmitted and/or received by various devices in the network, such as computer systems, remote data storage systems, etc. The time taken by a packet of data to travel from one point to another point in a network is referred to as latency. In terms of serving a request, latency includes the time gap between a request for service made at a system, processing of data according to the request for service made which may include communication with other devices/entities in the network, and the response (to the request made) served at the system. A communication network (which may be construed as a collection of devices that can communicate with each other to exchange data) with a longer delay or lag has high latency, while a communication network with fast response time has low latency. Also, high network latencies cause application performance to degrade, while low latency contributes to improved user experience, higher efficiency, better real-time processing, and reduction in operational costs.

Data in the network experiences latency due to various reasons, such as, but not limited to, inter-service communication (microservices communicate over a network using various protocols like hypertext transfer protocols where delays in data transmission may be introduced due to various attributes related to the protocols, such as the physical distance between services, network congestion, and bandwidth limitations), excessive service calls (microservices often call other services to fulfil a request introducing latency for each call and adding up leading to significant overall delays), inter-service messages (microservices with high frequency of inter-service messages suffer from increased latency due to overhead of each network call), containerization and virtualization (microservices often run in containers or virtual machines, which introduce additional layers of abstraction, each layer adding some overhead in terms of resource usage and latency).

When a microservice (for example, first microservice) of one web application associated with a web browser interacts with another microservice (for example, second microservice) of another web application within the web browser, deploying the docker containers of the microservices (for example, the first microservice and the second microservice) in a browser-based application deployment cluster at least reduces latency. The browser-based application deployment cluster may be an in-browser cluster associated with an open-source container orchestration system for automating software deployment, scaling, and management. The latency is reduced for inter-web application in-browser communication, by allowing web applications to call other in-browser web applications by sending details in the hypertext transfer protocol (HTTP) header. Additionally, deployment of the docker containers of the microservices in a browser-based application deployment cluster secures the resources (e.g., pods, persistent volume claims (PVC), secrets, config maps, etc.) allocated to a web application, by restricting access to its namespace by the web application and eases the management of resource permissions. For example, the resources management can be done at the namespace level according to the data traffic being handled by the web application and policies can be configured to perform various operations such as allowing or restricting PVC creation, scaling pods, secret creation, etc. Further, deployment of the docker containers of the microservices in a browser-based application deployment cluster grants and limits usage of in-browser computing resources at the namespace level for better management and distribution of the memory, compute processing unit (CPU), storage, and bandwidth of the device. For example, a resource optimizer may be used for up-scaling or down-scaling the resources allocated to a namespace of an application according to the data traffic handled by the application.

In various embodiments of the disclosure, a computer-implemented method for inter-application communication in a browser-based application deployment cluster is provided. The computer-implemented method includes receiving, by a computer, a first request to access a first microservice associated with a first application. The first request is received from a web-browser application installed on the computer. The computer-implemented method further includes determining, by the computer, a presence or absence of the first microservice associated with the first application in a browser-based application deployment cluster associated with the web-browser application. The presence or absence of the first microservice is determined based on the first request. The computer-implemented method further includes transmitting, by the computer, the first request to the first microservice based on the presence of the first microservice in the browser-based application deployment cluster. The transmission of the first request directly to the first microservice present in the browser-based application deployment cluster avoids additional processing and delays (for example, processing calls such as GET requests, PUT requests, POST requests, etc.) which otherwise would be introduced due to calls being made for accessing services associated with the first application. For example, a retail application includes an order service, and a payment application includes a payment service. When an order is placed using the retail application, the order service communicates with the payment service of the payment application. According to the traditional methods, for the communication between the order service of the retail application and the payment service of the payment application, the first microservice (such as the order service) makes an HTTP request to the second microservice (such as the payment service). Also, the process involves specifying the APIs for each microservice, which includes specifying endpoints, request/response formats, authentication mechanisms, etc. for each microservice. Further, a service discovery mechanism is implemented as the first microservice needs to know the location (IP address and port) of the second microservice to communicate with the second microservice. In the service discovery mechanism, the first microservice for getting location information of the second microservice, queries a service discovery server for the location of the second microservice. The service discovery server searches for the location of the second microservice in a service registry database where the locations of available service instances are stored. After the first microservice receives the location information of the second microservice, the first microservice can communicate with the second microservice. The service discovery is one example of a set of calls made for communication between the first microservice and the second microservice, and there may be multiple set of calls made in the process of communication between two microservices associated with different applications. Clearly, each set of calls introduces some latency and consumes computing resources. However, when the two microservices are present in the same browser-based application deployment cluster, avoidable calls that are made for communication between applications are avoided, as explained above. When the computer receives the first request to access the first microservice, the computer checks if the first microservice is present in the browser based application deployment cluster of the computer. If the first microservice is present in the browser based application deployment cluster of the computer, then there is no need to transmit the request to an external server and communicate with the external server following the service discovery mechanism as explained above. Instead, the computer directly transmits the first request to the first microservice present in the browser based application deployment cluster of the computer. For example, the first request for accessing the first microservice is received from a second application, where the first application and second application are already deployed in the browser based application deployment cluster of the web browser installed on the computer. The computer checks the presence of the first microservice deployed in the browser based application deployment cluster and directly transmits the first request to the first microservice. Further, edge-to-edge communication takes place between the first microservice and the second microservice without the involvement of an external server. Consequently, the resources are saved by avoiding the processing of the calls that would have been made for communicating with the external server, and latency is reduced. Additionally, the end-user gets a quicker response (as compared to the traditional approach) to the request made at the computer. Also, the user experience is enhanced at least in terms of response time. Further, the cost for an application owner, which is incurred for utilization of cloud resources, also gets reduced as a lesser amount of resources is used due to a reduction in processing requirements.

In various embodiments of the disclosure, the computer-implemented method further includes determining, by the computer, the absence of the first microservice in the browser-based application deployment cluster. The computer-implemented method further includes transmitting, by the computer, the first request to a server based on the absence of the first microservice in the browser-based application deployment cluster. The first application is hosted on the server.

In various embodiments of the disclosure, the computer-implemented method further includes receiving, by the computer, a response from the server based on the transmission of the first request to the server. The response is indicative of a deployment of at least the first microservice in the browser-based application deployment cluster. The computer-implemented method further includes retrieving, by the computer, first microservice data associated with at least the first microservice based on the response.

In various embodiments of the disclosure, the computer-implemented method further includes determining, by the computer, an availability of a set of resources of the computer based on the first microservice data. The computer-implemented method further includes creating, by the computer, a namespace for the first microservice in the browser-based application deployment cluster based on the determination of the availability of the set of resources of the computer. The set of resources of the computer is allocated to the created namespace.

In various embodiments of the disclosure, the computer-implemented method further includes deploying, by the computer, the first microservice in the browser-based application deployment cluster based on the created namespace and the first microservice data. The computer-implemented method further includes storing, by the computer, a mapping of the namespace and an identifier associated with the first microservice in a mapping database.

In various embodiments of the disclosure, the computer-implemented method further includes determining, by the computer, an unavailability of a set of resources of the computer based on the first microservice data. The computer-implemented method further includes transmitting, by the computer, the first request to the server based on the determination of the unavailability of the set of resources of the computer.

In various embodiments of the disclosure, the computer-implemented method further includes receiving, by the computer, a second request to access a second microservice associated with a second application. The second request is received from the first microservice of the first application. Further, the second microservice is deployed in the browser-based application deployment cluster. The computer-implemented method further includes transmitting, by the computer, the second request to the second microservice based on the reception of the second request.

In various embodiments of the disclosure, the computer-implemented method further includes receiving, by the computer, a set of requests for accessing the first microservice deployed in the browser-based application deployment cluster. The set of requests includes the first request. The computer-implemented method further includes determining, by the computer, a count of the received set of requests. The computer-implemented method further includes comparing, by the computer, the count with a threshold count. The computer-implemented method further includes modifying, by the computer, a set of resources of the computer based on the comparison of the count with the threshold count. The set of resources is associated with the first microservice.

In various embodiments of the disclosure, the computer-implemented method further includes determining, by the computer, a deployment time associated with the first microservice. The computer-implemented method further includes comparing, by the computer, the deployment time with a threshold deployment time. The computer-implemented method further includes modifying, by the computer, the set of resources of the computer, based on the comparison of the deployment time with the threshold deployment time. The set of resources is associated with the first microservice.

In various embodiments of the disclosure, the computer-implemented method further includes determining, by the computer, a first version of the first microservice associated with the first application. The computer-implemented method further includes determining, by the computer, an availability of a second version of the first microservice based on the determined first version. The computer-implemented method further includes retrieving, by the computer, second microservice data associated with the second version of the first microservice. The computer-implemented method further includes deploying, by the computer, the second version of the first microservice in the browser-based application deployment cluster based on the retrieved second microservice data.

In various embodiments of the disclosure, the computer-implemented method further includes querying, by the computer, a mapping database for the presence or the absence of the first microservice in the browser-based application deployment cluster based on the first request. The computer-implemented method further includes receiving, by the computer, a response based on the querying of the mapping database. The computer-implemented method further includes determining, by the computer, the presence or the absence of the first microservice in the browser-based application deployment cluster based on the response.

In various embodiments of the disclosure, a computer system for inter-application communication in a browser-based application deployment cluster is provided. The computer system includes a processor set, one or more computer-readable storage media, and program instructions stored on the one or more computer-readable storage media. The program instructions are executable by the processor set to cause the processor set to receive a first request to access a first microservice associated with a first application. The first request is received from a second microservice associated with a second application. Further, the second microservice is present in a browser-based application deployment cluster associated with a web-browser application installed on the computer system. The program instructions further cause the processor set to determine a presence of the first microservice associated with the first application in the browser-based application deployment cluster associated with the web-browser application. The presence of the first microservice is determined based on the received first request. The program instructions further cause the processor set to transmit the first request to the first microservice based on the determined presence of the first microservice in the browser-based application deployment cluster.

In various embodiments of the disclosure, the program instructions further cause the processor set to receive a set of requests for accessing the first microservice deployed in the browser-based application deployment cluster. The set of requests includes the first request. The program instructions further cause the processor set to determine a count of the received set of requests. The program instructions further cause the processor set to compare the count with a threshold count. The program instructions further cause the processor set to modify a set of resources of the computer system based on the comparison of the count with the threshold count. The set of resources is associated with the first microservice.

In various embodiments of the disclosure, the program instructions further cause the processor set to determine a deployment time associated with the first microservice. The program instructions further cause the processor set to compare the deployment time with a threshold deployment time. The program instructions further cause the processor set to modify a set of resources of the computer system, based on the comparison of the deployment time with a threshold deployment time. The set of resources is associated with the first microservice.

In various embodiments of the disclosure, the program instructions further cause the processor set to determine a first version of the first microservice associated with the first application. The program instructions further cause the processor set to determine an availability of a second version of the first microservice based on the determined first version. The program instructions further cause the processor set to retrieve second microservice data associated with the second version of the first microservice. The program instructions further cause the processor set to deploy the second version of the first microservice in the browser-based application deployment cluster based on the retrieved second microservice data.

In various embodiments of the disclosure, a computer program product for transmitting a request for accessing a microservice deployed in a browser-based application deployment cluster is provided. The computer program product includes one or more computer-readable storage media. The program instructions stored on the one or more computer-readable storage media to perform operations. The operations include receiving the request to access the microservice associated with an application. The request is received from a web-browser application. The operations include determining a presence or an absence of the microservice associated with the application in the browser-based application deployment cluster associated with the web-browser application. The presence of the microservice is determined based on the request. The operations include transmitting the request to the microservice based on the presence of the microservice in the browser-based application deployment cluster.

In various embodiments of the disclosure, the operations include determining the absence of the microservice in the browser-based application deployment cluster. The operations include transmitting the request to a server based on the determined absence of the microservice in the browser-based application deployment cluster. The application is hosted on the server.

In various embodiments of the disclosure, the operations include receiving a response from the server based on the transmission of the request to the server. The response is indicative of a deployment of at least the microservice in the browser-based application deployment cluster. The operations include retrieving microservice data associated with at least the microservice based on the response.

In various embodiments of the disclosure, the operations include determining an availability of a set of resources of a computer associated with the computer program product, based on the microservice data. The operations are performed by the computer. The operations include creating a namespace for the microservice in the browser-based application deployment cluster based on the determination of the availability of the set of resources of the computer. The set of resources of the computer is allocated to the created namespace.

In various embodiments of the disclosure, the operations include deploying the microservice in the browser-based application deployment cluster based on the created namespace and the microservice data. The operations include storing a mapping of the namespace and an identifier associated with the microservice in a mapping database.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (also referred to as CPP embodiment, or CPP) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the disclosure, is not to be construed as storage in the generation of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

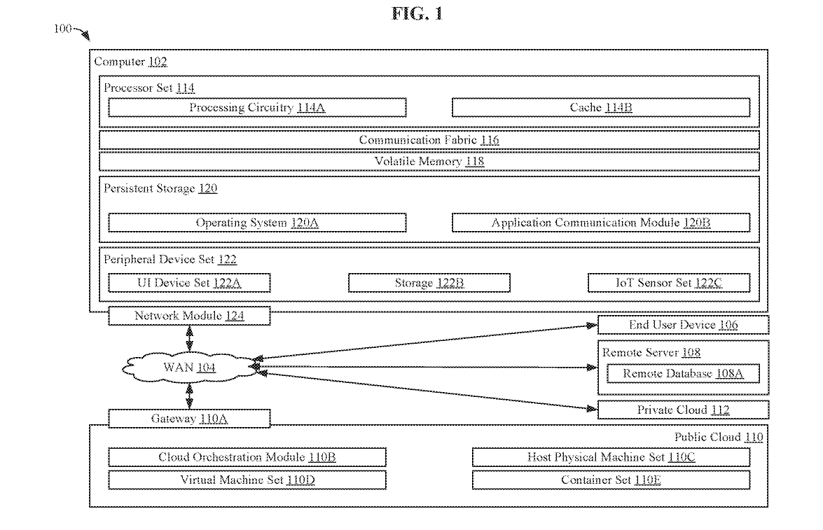

FIG. 1 is a diagram that illustrates a computing environment 100 for inter-application communication in a browser-based application deployment cluster, in accordance with various embodiments of the disclosure. The diagram contains an exemplary environment for the execution of at least one module involved in performing the methods, such as an application communication module 120B associated with inter-application communication in a browser-based application deployment cluster. In addition to the application communication module 120B, computing environment 100 includes, for example, a computer 102, a wide area network (WAN) 104, an end user device (EUD) 106, a remote server 108, a public cloud 110, and a private cloud 112. In various embodiments of the disclosure, the computer 102 includes a processor set 114 (including a processing circuitry 114A and a cache 114B), a communication fabric 116, a volatile memory 118, a persistent storage 120 (including an operating system 120A and the application communication module 120B, as identified above), a peripheral device set 122 (including a user interface (UI) device set 122A, a storage 122B, an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that runs a program, accessing a network or querying a database, such as a remote database 108A. As is well understood in the art of computer technology, and depending upon the technology, the performance of a computer-implemented method may be distributed among multiple computers and/or between multiple locations. In various embodiments of the disclosure, in the presentation of the computing environment 100, detailed discussion is focused on a single computer, specifically the computer 102, to keep the presentation as simple as possible. The computer 102 may be located in a cloud, even though the computer 102 located in the cloud is not shown in a cloud in FIG. 1. In various embodiments, computer 102 is not located in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located off-chip. In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as the methods). These computer-readable program instructions are stored in various types of computer-readable storage media, such as the cache 114B and the other storage media discussed below. The program instructions and associated data are accessed by the processor set 114 to control and direct the performance of the methods. In computing environment 100, at least some of the instructions for performing the methods may be stored in the application communication module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, in case affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of the persistent storage 120 means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The application communication module 120B typically includes at least one module involved in performing the methods.

The peripheral device set 122 includes the set of peripheral devices of computer 102. Data communication connections between the peripheral devices and the other components of computer 102 may be implemented in various ways, such as Bluetooth connections, near-field communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is has a large amount of storage (for example, where computer 102 locally stores and manages a large database) then the storage 122B may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) that communicates computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, the recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then the historical data may be provided to the computer 102 from the remote database 108A of the remote server 108.

The public cloud 110 is any computer system available for use by multiple entities that provides on-demand availability of computer system resources and/or other computing operations, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments (VCEs) that run on various computers making up the computers of the host physical machine set 110C, which is the universe of physical computers in and/or available to the public cloud 110. The VCEs typically take the form of virtual machines from the virtual machine set 110D and/or containers from the container set 110E. The VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. The container using operating-system-level virtualization refers to an operating system feature in which the kernel allows the existence of multiple isolated user-space instances, called containers. These isolated user-space instances typically behave as real computers from the point of view of programs running in them. A computer program running on an ordinary operating system can utilize resources of that computer, such as connected devices, files and folders, network shares, CPU power, and quantifiable hardware operations. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In various embodiments of the disclosure, the public cloud 110 and the private cloud 112 are both part of a larger hybrid cloud.

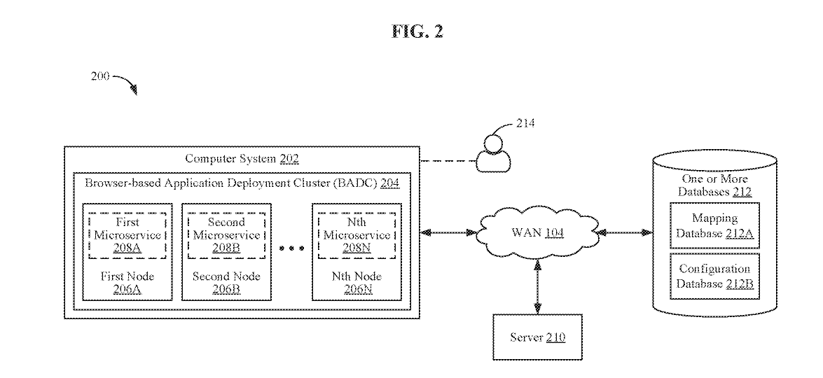

FIG. 2 is a diagram that illustrates an environment for inter-application communication in a browser-based application deployment cluster, in accordance with various embodiments of the disclosure. FIG. 2 is explained in conjunction with elements from FIG. 1. With reference to FIG. 2, there is shown a diagram of a network environment 200. The network environment 200 includes a computer system 202 (also referred to as system 202), a browser-based application deployment cluster (BADC) 204, a first node 206A, a second node 206B, up to an Nth node 206N executing a first microservice 208A, a second microservice 208B, up to an Nth microservice 208N respectively. The network environment 200 further includes a server 210, one or more databases 212, and a user 214 associated with the computer system 202. In an embodiment, the one or more databases 212 includes a mapping database 212A and a configuration database 212B. The network environment 200 further includes the WAN 104 of FIG. 1. In various embodiments of the disclosure, the computer system 202 is an exemplary embodiment of the computer 102 in FIG. 1.

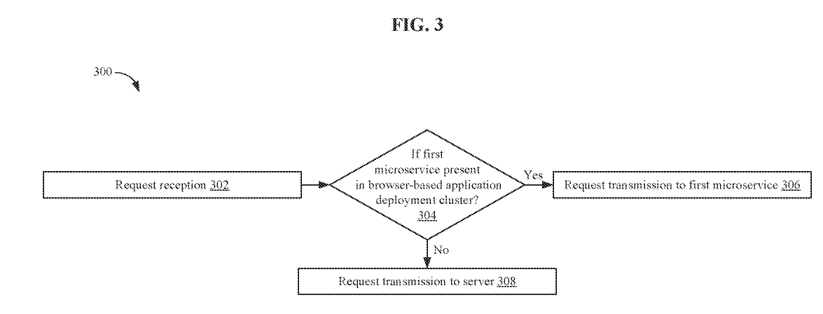

The computer system 202 includes suitable logic, circuitry, and/or interfaces for inter-application communication in the BADC 204. The computer system 202 is configured to receive a first request to access the first microservice 208A. The first microservice 208A is associated with a first application. The first request is received via a web-browser application that is installed on the computer system 202. Further details on the first request are provided in the disclosure with reference to FIG. 3.

In an embodiment, a uniform resource indicator (URI) or a uniform resource locator (URL) is associated with the first application. The URL or URI is used to access the first application via a web browser application installed on the computer system 202. In an embodiment, the computer system 202 is further configured to determine the presence or absence of the first microservice 208A associated with the first application in the BADC 204 associated with the web-browser application. The presence of the first microservice 208A is determined based on the reception of the first request. In other words, when the computer system 202 receives the first request, then the computer system 202 checks and determines the presence or absence of the first microservice in the BADC 204. For determining the presence or absence of the first microservice in the BADC 204, the computer system 202 is configured to query the mapping database 212A for the presence or the absence of the first microservice 208A in the BADC 204. The mapping database 212A refers to a database that is configured to store mapping data of the microservices deployed in the BADC 204 and the uniform resource locators (URLs) of the applications associated with the microservices. The mapping data of microservices deployed in the BADC 204 and the URLs of the applications associated with the microservices may be stored in tabular form, etc. The mapping data indicates the mapping of a microservice that is deployed in the BADC 204 with a respective URL of a web application to which the microservice is associated. Thus, in an exemplary table stored in the mapping database 212A, a URL of a web application may be mentioned against an identifier of a microservice.

In various embodiments of the disclosure, the computer system 202 is configured to receive a response to the query from the mapping database 212A. Further, the computer system 202 is configured to determine the presence or the absence of the first microservice 208A in the BADC 204 based on the received response. The computer system 202 is further configured to transmit the first request to the first microservice in case the first microservice is present in the browser-based application deployment cluster. Examples of the computer system 202 include but are not limited to, a computing device, a computer workstation, a mainframe machine, a smartphone, a cellular phone, a mobile phone, a gaming device, or any other consumer electronic (CE) device.

In various embodiments of the disclosure, the BADC 204 includes a set of nodes that can run containerized applications in an efficient and automated manner. In a non-limiting example, the BADC 204 is a cluster associated with a web browser application on the computer system 202. The web browser application may be associated with a command line interface, an application programming interface, and a dashboard. Pertinently, throughout the disclosure, the term browser-based or in-browser refers to the components that are associated with a web browser application. For example, the BADC 204 refers to an application deployment cluster that is associated with a web browser application.

In various embodiments of the disclosure, the BADC 204 includes the set of nodes that includes the first node 206A, the second node 206B, to the Nth node 206N. Each node of the set of nodes may be executing one or more microservices. For example, the first node 206A may execute the first microservice 208A, the second node 206B may execute the second microservice 208B, and the Nth node 206N may execute the Nth microservice 208N. The set of nodes may be a virtual machine that provides computational resources to run containerized applications.

The one or more microservices may include any number of microservice(s). For example, the first microservice 208A includes a specific service that may be a part of a first application and may be hosted on the first node 206A. Similarly, in another example, the second microservice 208B may be a part of a second application and may be hosted on the second node 206B. Each microservice of the one or more microservices operates as a self-contained unit, encapsulating its own logic, data storage, and communication interfaces, and can be developed, deployed, and scaled independently of other services within the application.

The server 210 includes suitable logic, circuitry, interfaces, and/or code that are configured to host one or more applications. The server 210 may be implemented as a cloud server and may execute operations through web applications, cloud applications, HTTP requests, repository operations, file transfer, and the like. Other example implementations of the server 210 may include, but are not limited to, a database server, a file server, a web server, an application server, or a cloud computing server. In at least one embodiment, the server 210 may be implemented as a plurality of distributed cloud-based resources by use of several technologies that are well known to those ordinarily skilled in the art. Although only one server 210 is shown in FIG. 2, the disclosure encompasses one or more servers that may implement the features of the present disclosure. In various embodiments of the disclosure, where the first microservice 208A is absent in the BADC 204, the computer system 202 is configured to transmit the first request to the server 210 (located external to the computer system 202) which hosts the first application.

Each of the one or more databases 212 corresponds to an organized collection of data that may be stored and accessed electronically from a computer system (such as the computer system 202). In various embodiments of the disclosure, the one or more databases 212 includes at least a mapping database 212A and a configuration database 212B. In various embodiments of the disclosure, the computer system 202 is configured to check and determine the presence or absence of the first microservice 208A in the BADC 204. For determination of the presence or absence of the first microservice 208A in the BADC 204, the computer system 202 is configured to query the mapping database 212A. Based on the query, the computer system 202 is configured to receive a response to the query from the mapping database 212A. Further, the computer system 202 is configured to determine the presence or the absence of the first microservice in the browser-based application deployment cluster based on the received response. Further, the configuration database 212B is configured to store the configuration data of the one or more microservices deployed in the BADC 204. Examples of the configuration data include, but are not limited to, external dependencies of the microservice such as database URLs, third-party application programing interfaces, messaging queues etc., usernames and passwords, connection pool settings, service port numbers, encryption keys, security settings, etc. Also, the structure of each database of the one or more databases 212 typically involves tables, records, and fields that can be managed through various database management systems (DBMS). Examples of each database of the one or more databases 212 may include, but are not limited to, a relational database, a not only structured query language (NoSQL) database, a hierarchical database, a network database, a transactional database, a data warehouse, and a distributed database. Examples of the data include, but are not limited to, set of resources allocated to a namespace, deployment time, threshold deployment time, first version and second version of the first microservice, etc. which are explained later in the disclosure. For the purposes of the disclosure, the set of resources includes, but is not limited to, computing resources, network resources, storage resources, etc. of the computer system 202, unless otherwise indicated.

In operation, the computer system 202 is configured to receive the first request to access the first microservice 208A associated with the first application. In an embodiment, the first request is received from a web-browser application installed on the computer system 202. Based on the reception of the first request, the computer system 202 is further configured to determine the presence or the absence of the first microservice 208A associated with the first application in BADC 204 associated with the web-browser application. In case the first microservice 208A is present in the BADC 204, then the computer system 202 is configured to transmit the first request to the first microservice 208A.

Otherwise, in case the first microservice 208A is absent in the BADC 204, then the computer system 202 is configured to transmit the first request to the server 210 where the first application is hosted. Further details about the process of determination of the presence or the absence of the first microservice 208A in BADC 204 are provided, for example, in FIG. 3.

Additionally, along with the transmission of the first request to the server 210, the computer system 202 is configured to check if the first microservice 208A is available to be deployed at the BADC 204 or not. In case the first microservice 208A is not available to be deployed at the BADC 204, then the first microservice 208A does not get deployed in the BADC 204 and the process ends. However, if the first microservice 208A is available to be deployed at the BADC 204, then the computer system 202 is configured to check the availability of a set of resources in the computer system 202 for hosting the first microservice 208A.

If the set of resources is not available with the computer system 202, then the first microservice 208A does not get deployed in the BADC 204 and the process ends. However, in case the set of resources is available, then the computer system 202 is configured to create a new namespace for the first microservice 208A and use the newly created namespace for hosting the first microservice 208A. Further, the computer system 202 is configured to deploy the first microservice 208A at the BADC 204 and transmit the first request to the first microservice 208A deployed at the BADC 204.

FIG. 3 is a diagram that illustrates exemplary operations for transmitting a request related to inter-application communication in a browser-based application deployment cluster, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 308, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a request reception operation is executed. In the request reception operation, the computer system 202 is configured to receive the first request. In an embodiment, the first request is a Hypertext Transfer Protocol (HTTP) request, for example, a GET request that is used to read/retrieve data from a web server. In an embodiment, the first request is to access the first microservice 208A associated with a first application. The first application is a microservice architecture based containerized application that may provide one or more services to the user 214. In an embodiment, the computer system 202 is configured to receive the first request at a user interface of the computer system 202. For example, the computer system 202 may include a touchscreen for inputting a URL for accessing the first application.

By way of example and not by limitation, the first request may be the HTTP request to access a login page (or a login service) of the first application with the URL as “xyz1.com”. In this example, the first microservice 208A is the microservice that hosts the login page. Also, the first request is received from the web-browser application installed on the computer system 202. With reference to the example, the user 214 may be operating the computer system 202 and may wish to access the first microservice 208A that is associated with the first application.

In an alternate embodiment of the disclosure, the computer system 202 is configured to receive a first request from a second microservice 208B associated with a second application. The second microservice 208B may transmit the first request for accessing the first microservice 208A via the web browser application installed on the computer system 202. In an embodiment, the second microservice 208B may be deployed in the BADC 204. In an alternate embodiment, the second microservice 208B may not be deployed in the BADC 204 and may be hosted on the server 210.

At 304, it may be checked if the first microservice 208A is present in the BADC 204. Specifically, the computer system 202 is configured to check whether the first microservice 208A is present in the BADC 204 or not. In an embodiment of the disclosure, after receiving the first request, the computer system 202 is configured to check and determine the presence or the absence of the first microservice 208A in the BADC 204 associated with the web-browser application. The presence of the first microservice 208A in the BADC 204 implies that the BADC 204 has computing resources and other resources (such as, but not limited to, networking resources, storage resources, memory resources, etc.) allocated to the first microservice 208A for enabling the first microservice 208A to perform operations as disclosed in the disclosure. Also, since the BADC 204 is present on the computer system 202 locally, the presence of the first microservice 208A in the BADC 204 implies that the first microservice 208A uses the resources of the computer system 202.

In an embodiment of the disclosure, the computer system 202 is configured to query the mapping database 212A to determine the presence or the absence of the first microservice 208A in the BADC 204 based on the reception of the first request. The computer system 202 may query the mapping database 212A using any known technique, such as, but not limited to, keyword searching (which involves entering one or more keywords or phrases into a search query to retrieve records that contain those specific terms), Boolean searching (which involves combining keywords using Boolean operators (such as AND, OR, and NOT) to refine search queries), etc. In a non-limiting example, a SELECT statement in the structured query language (SQL) may be used by the computer system 202 for querying the mapping database 212A. For example, while using the SELECT statement, a query such as SELECT MS_Name FROM MappingTable where MS_ID = 1234XX may be transmitted by the computer system 202 to the mapping database 212A. For the purposes of the provided example, the MS_Name is the name of the first microservice 208A, and 1234XX is the identifier of the first microservice 208A. The MappingTable is the table that includes a list of microservices deployed in the BADC 204, a list of identifiers of the list of microservices deployed in the BADC 204, and a list of node identifiers where each microservice is deployed in the BADC 204. In an embodiment, the identifier of the first microservice 208A may be included in the first request. The computer system 202 may be configured to retrieve the identifier of the first microservice 208A from the first request and query the mapping database 212A.

In an embodiment of the disclosure, the computer system 202 is configured to receive a response from the mapping database 212A based on the query transmitted to the mapping database 212A. In case the first microservice 208A is present in the BADC 204, the mapping database 212A is configured to transmit a response with the identifier of the first microservice 208A indicating the presence of the first microservice 208A in the mapping database 212A and the identifier of the first node 206A where the first microservice 208A may be deployed.

Alternatively, if the first microservice 208A is not present in the BADC 204, the mapping database 212A is configured to transmit a response (for example, NULL) indicating the absence of the first microservice 208A in the mapping database 212A. In case the first microservice 208A is present in the BADC 204, the control may be transferred to 306. Otherwise, if the first microservice 208A is absent in the BADC 204, the control may be transferred to 308.

At 306, a request transmission to the first microservice operation is executed. In the request transmission to the first microservice operation, the computer system 202 is configured to transmit the first request to the first microservice 208A deployed in the BADC 204 based on the determination that the first microservice 208A is present in the BADC 204. In the case of the transmission of the first request to the first microservice 208A deployed in the BADC 204, the computer system 202 avoids the operations of communicating the first request to the server 210 which is hosting the first application.

The above method saves computing resources and time, and therefore, latency (that may be introduced due to application calls made and their processing involved in the process) is reduced as compared to the traditional methods where the computer system 202 communicates with the server 210 that hosts the first application. For example, a request to access the first microservice 208A is received from the second microservice 208B on the web browser. According to the traditional methods, for the communication between the first microservice 208A and the second microservice 208B, a call would be made to a server that hosts the first microservice 208A would be made. For this, the URL associated with the first application associated with the first microservice 208A would be checked. Further, the request would be routed to the server where the first application is hosted. The authentication of the first request may be optionally performed to check whether the request is received from an eligible entity or no entity involved in the communication is compromised, to ensure the security of data. Further, the request would be transmitted to the first microservice 208A so that the request from the second microservice 208B can be served by the first microservice 208A. Once the first microservice 208A serves the request received from the second microservice 208B, a response associated with the request being served is transmitted to the second microservice 208B. One having ordinary skill in the art can easily figure out the number of calls that must be made to perform the entire process as noted above, the amount of computing and other resources to fulfill the request, and the time that would take for processing the calls. On the contrary, implementing the features of the disclosure, as explained above, when the two microservices, e.g., the first microservice 208A and the second microservice 208B, are present in the BADC 204, a majority of calls that are made for communication between the first microservice 208A and the second microservice 208B are avoided and the resources are saved for other purposes and latency is reduced as compared to the traditional methods as explained above. In a hypothetical case, for example, the latency is time between sending a request from the second microservice 208B to the first microservice 208A. Say for example, the second microservice 208B is present in the BADC 204 of the computer system 202, and the first microservice 208A is present in the server 210. Say for example, a time gap between the instance of the computer system 202 sending the first request till the instance of the server 210 receiving the first request is Time A. Continuing with the example, say a time gap between the instance of the server 210 starting processing the first request till the server 210 completing sending the response for the first request is Time B. Continuing with the example, say a time gap between the instance of the server 210 completing sending the response for the first request till the instance of the computer system 202 starting receiving the response is Time C. Continuing with the example, say a time gap between the instance of the computer system 202 starting processing the response till the computer system 202 completing processing the response is Time D. For example, the Time A = 80 milli seconds (ms), Time B = 70ms, and Time C = 100ms, and Time D = 150ms. Now, if the second microservice 208B is present in the BADC 204 computer system 202, and the first microservice 208A is present at the server 210, then the latency would be Time A + Time B + Time C = (80+70+100+150) ms = 400 ms. However, if the first microservice 208A and the second microservice 208B both are present in the BADC 204 in the computer system 202, then at least the Time A and Time C can be reduced or avoided. Thus, the latency (where the first microservice 208A and the second microservice 208B both are present in the BADC 204 in the computer system 202) would be Time B + Time C = (70+150) ms = 220 ms, and the latency would reduce by 180 ms.

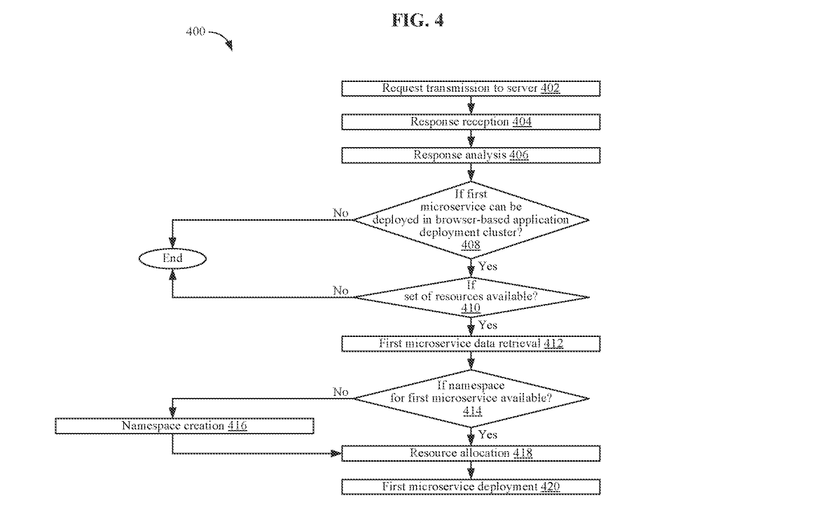

At 308, a request transmission to server operation is executed. In the request transmission to server operation, the computer system 202 is configured to transmit the first request to the server 210 based on the determination that the first microservice 208A is absent in the BADC 204. The server 210 may be located external to the computer system 202. Thus, the computer system 202 may use known procedures for transmitting the first request to the server 210 and connecting with the server 210. The server 210 hosts the first application. In such a case, the first microservice 208A uses the resources (such as CPU, RAM, storage, etc.) of the server 210 and not the computer system 202. Also, the server 210 may be hosted at a domain on the cloud, internet, or such network. In case the computer system 202 transmits the first request to the server 210 based on the determination that the first microservice 208A is absent in the BADC 204, the computer system 202 may deploy the first microservice 208A as explained with reference to FIG. 4 in the disclosure.

FIG. 4 is a diagram that illustrates exemplary operations for the deployment of a microservice in a browser-based application deployment cluster, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 420, as described herein. The exemplary operations illustrated in the block diagram 400 may start at 402 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a request transmission to server operation is executed. In the request transmission to server operation, the computer system 202 is configured to transmit the first request to the server 210 based on the determination that the first microservice 208A is absent in the BADC 204. The server 210 may be located external to the computer system 202. The computer system 202 may use known procedures for transmitting the first request to the server 210 and connecting with the server 210. The server 210 hosts the first application. In such a case, the first microservice 208A uses the resources (such as CPU, RAM, storage, etc.) of the server 210 and not the computer system 202. Also, the server 210 may be hosted at a domain on the cloud, internet, or such network.

In an alternate embodiment, the computer system 202 may be configured to transmit a deployment request to the server 210 to check whether the first microservice 208A of the first application can be deployed locally on the computer system 202. This may be done based on multiple factors such as, but not limited to, a count of requests from the user 214 to access the first microservice 208A is greater than a threshold count. In case the count of requests from the user 214 to access the first microservice 208A is greater than the threshold count, it may be deemed that the user 214 frequently accesses the first microservice 208A, therefore it may be better to deploy the first microservice 208A locally, in case it is deployable.

At 404, a response reception operation is executed. In the response reception operation, the computer system 202 is configured to receive a response from the server 210 based on the transmission of the first request to the server 210. The response transmitted by the server 210 to the computer system 202 may be an HTTP response. Also, the HTTP response transmitted by the server 210 includes an HTTP status code. The status code of the HTTP response may be as per defined standards related to HTTP. For example, the status code can be 100-199 for informational responses, 200-299 for successful responses, 300-399 for redirection messages, 400-499 for client error responses, and 500-599 for server error responses.

At 406, a response analysis operation is executed. In the response analysis operation, the computer system 202 is configured to analyze the HTTP status code of the response received from the server 210. The HTTP status code indicates whether the first microservice 208A is available to be deployed (or hosted) in the BADC 204 or not. Specifically, the HTTP status code indicates whether the first microservice 208A can be deployed (or hosted) in the BADC 204 or not Thus, the computer system 202 is configured to analyze the response for determining whether the first microservice 208A can be deployed (or hosted) in the BADC 204.

At 408, it may be determined if the first microservice 208A can be deployed in the BADC 204. Specifically, the computer system 202 is configured to determine whether the first microservice 208A is available to be deployed (or hosted) in the BADC 204 or not, based on the analysis of the response. If the HTTP status code of the response indicates that the first microservice 208A is available to be deployed in the BADC 204, then the control may be transferred to 410. Otherwise, if the HTTP status code indicates that the first microservice 208A is not available to be deployed in the BADC 204, then the computer system 202 does not deploy the first microservice 208A in the BADC 204, and the process ends.

As discussed above, in various embodiments of the disclosure, the execution of the process for deployment of the first microservice 208A at the BADC 204 is based on the count of requests received by the computer system 202 for accessing the first microservice 208A. In various embodiments of the disclosure, the computer system 202 is configured to receive the set of requests received for accessing the first microservice 208A. The set of requests includes the first request. Further, the computer system 202 is configured to determine the count of the received set of requests received for accessing the first microservice 208A. The count of the set of requests is a count of the requests that may be made for accessing the first microservice 208A in a defined time interval. The computer system 202 is configured to compare the count with the threshold count. The threshold count for a microservice ‘A’ indicates the maximum number of requests that are received at the computer system 202 for accessing the microservice ‘A’, before deployment of the microservice ‘A’ at the BADC 204. Thus, in case the count of requests made to access the first microservice 208A is greater than the threshold count, the process for deployment of the first microservice 208A in the BADC 204 is executed by the computer system 202. Also, in an alternate embodiment, the process for deployment of the first microservice 208A in the BADC 204 is not executed based on the comparison of the count of the received set of requests with the threshold count but is executed based on the availability of the first microservice 208A to be deployed at the BADC 204.

At 410, it is determined if a set of resources is available at the computer system 202 for the deployment of the first microservice 208A in the BADC 204. Specifically, the computer system 202 is configured to check whether the set of resources is available with the computer system 202 locally or not. In various embodiments, the set of resources includes computing resources and other resources that may be required for deploying the first microservice 208A in the BADC 204. The checking for the availability of the set of resources is performed as the first microservice 208A uses computing, storage, networking, and other resources for its deployment on the BADC 204. In an embodiment, the checking of the availability of the set of resources is based on a threshold amount of resources. The computer system 202 may determine an availability or an unavailability of the set of resources using a monitoring unit. For example, the threshold amount of resources includes 16 gigabytes (GB) of RAM and 100 GB of storage capacity. In this example, if the monitoring unit of the computer system 202 determines that the computer system 202 has the availability of the set of resources greater than or equal to 16 GB of RAM and 100 GB of storage capacity, then the set of resources is determined as available. Pertinently, for determining that the set of resources is available, all values of the amount of resources available with the computer system 202 should satisfy the conditions of the respective threshold values. On the contrary, if the monitoring unit of the computer system 202 determines that the computer system 202 does not have the availability of the set of resources greater than or equal to 16 GB of RAM and 100 GB of storage capacity, then the set of resources is determined as unavailable. If the computer system 202 determines that the set of resources is available, then the control may be transferred to 412. Otherwise, if the computer system 202 determines that the set of resources is not available, then the computer system 202 does not deploy the first microservice 208A in the BADC 204, and the process ends.

At 412, a first microservice data retrieval operation is executed. In the first microservice data retrieval operation, the computer system 202 is configured to retrieve the first microservice data associated with the first microservice 208A. The first microservice data refers to the data that is used to host the first microservice 208A at the BADC 204. The microservice data may refer to the specific data requirements and structures that the first microservice needs to function effectively within a microservices architecture. Each microservice may designed to handle a particular business capability and is responsible for managing its data. This promotes loose coupling between services, enhancing scalability and maintainability. The first microservice data associated with the first microservice may include, but is not limited to, configuration settings, user information, transactional data, and any other relevant information required for the first microservice to perform its tasks.

For example, in the context of a login service, which is a common microservice in many applications, the required microservice data encompasses several critical components. First and foremost, user credentials are required; this typically includes usernames and passwords. The service must handle these credentials securely, often employing encryption for both storage and transmission to protect against unauthorized access. Additionally, user profiles containing information such as email addresses, phone numbers, and user preferences are vital for personalizing the user experience. Another aspect of the login service is the management of authentication tokens. After a successful login, the service generates tokens (e.g., JSON Web Tokens or JWTs) that are used for session management and further authentication processes throughout the application. Access control data is also crucial; this includes information regarding user roles and permissions that dictate what resources the user can access within the application. Lastly, maintaining audit logs of login attempts—both successful and unsuccessful—is important for security monitoring and compliance purposes. Encapsulating all these data elements within the login service ensures that other services do not need direct access to sensitive information such as user credentials. This isolation enhances security while allowing for efficient management of authentication processes. Overall, effective management of microservice data is crucial for maintaining the integrity and performance of applications built on a microservices architecture.

In various embodiments of the disclosure, the first microservice data includes a header information of the response received from the server 210. The header information of the response may include, but is not limited to, data of the URL of the container image which needs to be deployed in the browser to host the microservice, a data related to persistent volume claims (PVC) for the pod for hosting the first microservice 208A, a data related to secrets for the pod, a data related to ConfigMap for the pod, a data related to scaling for the pod, etc. In an embodiment of the present disclosure, the first microservice data further includes configuration data of the first microservice 208A. The configuration data of the first microservice 208A refers to the set of parameters and settings that dictate the behaviour, environment, and operational characteristics of the first microservice 208A. Examples of the configuration data include, but are not limited to, external dependencies of the microservice such as database URLs, third-party application programming interfaces, messaging queues, etc., usernames and passwords, connection pool settings, service port numbers, encryption keys, security settings, etc. In an embodiment of the disclosure, the computer system 202 is configured to store the configuration data of the first microservice 208A in the configuration database 212B. Furthermore, the first microservice data includes a container image of the first microservice 208A.

At 414, it is determined if a namespace for the first microservice 208A is available. Specifically, the computer system 202 is configured to determine whether a namespace for deploying the first microservice 208A is available or not. Also, the computer system 202 is configured to check for the namespace based on the determination that the set of resources is available with the computer system 202 locally. Reiterating from above, the namespace for microservice refers to a mechanism for isolating groups of resources within a single cluster. The namespace provides a container to include functions, classes, and constants as a way to group them logically and to help avoid conflicts. Thus, the namespace associated with the first microservice 208A may be allocated with the set of resources (e.g., pods, services, deployments, and other objects) associated with the first microservice 208A for the deployment of the first microservice 208A at the BADC 204. In an embodiment, the computer system 202 is configured to determine that the namespace for the first microservice 208A is available in case the identifier of the namespace includes the domain name of the first application, with which the first microservice 208A is associated. For example, the namespace for the first microservice 208A may be identified as “Namespace_xyz1.com” or “xyz1.com”, where the first application is accessed with the URL “xyz1.com”. Pertinently, no two namespaces can have the same name in a single cluster. If the computer system 202 determines that the namespace for deploying the first microservice 208A is available, then the control may be transferred to 418. Otherwise, if the computer system 202 determines that the namespace for deploying the first microservice 208A is not available, then the control may be transferred to 416.

At 416, a namespace creation operation is executed. In the namespace creation operation, the computer system 202 is configured to create the namespace for the first application or the first microservice of the first application. For example, the computer system 202 creates a namespace with the identifier “xyz1.com” in the BADC 204, for the first application with the URL “xyz1.com”. The creation of a namespace for the first application eases the management of resource permissions by allowing or disallowing specific operations (for example, allowing or restricting PVC creation, scaling pods, secret creation, etc.) for the first microservice 208A associated with the first application, at the namespace level. The creation of the namespace for the first microservice 208A establishes a distinct environment within the BADC 204 to organize and isolate the set of resources for the first microservice 208A.

At 418, a resource allocation operation is executed. In the resource allocation operation, the computer system 202 is configured to allocate the set of resources to the namespace for the first microservice 208A. As discussed above, the set of resources includes, but is not limited to, computing resources, memory resources, networking resources, storage resources, etc. of the computer system 202. The set of resources is used to deploy the first microservice 208A in the BADC 204. The allocation of the set of resources to the namespace of the first application for deployment of the first microservice 208A secures the set of resources of the first application by restricting access to the namespace by the first microservice 208A and also limits usage of the set of resources at the namespace level for better management and distribution of the resources including memory, computing power, storage, etc. The set of resources for deployment of the first microservice 208A in the BADC 204 is allocated according to the first microservice data. For example, pods (which host the docker containers as mentioned in the first microservice data) are allocated according to the data of the URL of the container image which needs to be deployed in BADC 204 to host the first microservice 208A, persistent volume which utilizes the storage space of the computer system 202 is allocated according to persistent volume claims that are allocated according to the data related to persistent volume claims (PVC) for the pod for hosting the first microservice 208A, secrets (which contain configuration information encoded as base64 as key-value pairs as mentioned in the first microservice data are allocated according to the data related to secrets for the pod, ConfigMaps (which contain configuration information as key-value pairs as mentioned in the first microservice data) are allocated according to the data related to ConfigMap for the pod.

At 420, a first microservice deployment operation is executed. In the first microservice deployment operation, the computer system 202 is configured to deploy the first microservice 208A in the namespace for the first microservice 208A in the BADC 204. For deployment of the first microservice 208A in the namespace in the BADC 204, the computer system 202 is configured to either extract the container image of the first microservice 208A from the first microservice data or download the container image of the first microservice 208A using the data of URL of the container image which needs to be deployed in BADC 204 to host the first microservice 208A. For example, the computer system 202 downloads the container image of the first microservice 208A using the URL of the container image of the first microservice 208A as mentioned in the HTTP header of the response received by the computer system 202 from the server 210 and deploys the container image of the first microservice 208A in the BADC 204.

In an embodiment of the disclosure, the computer system 202 is configured to store a mapping of the namespace of the first microservice 208A and the identifier of the first microservice 208A in the mapping database 212A, based on the deployment of the first microservice 208A in the namespace in the BADC 204. For example, if the namespace for the first microservice 208A is “xyz1.com”, and the identifier of the first microservice 208A is “1234XX”, then the computer system 202 is configured to store the mapping in the mapping database 212A. The mapping may include the namespace for the first microservice 208A, e.g., “xyz1.com” against the identifier of the first microservice 208A, e.g., “1234XX”.

Also, in various embodiments, the computer system 202 is configured to modify the set of resources allocated to the first microservice 208A based on a count of requests received at the computer system 202 for accessing the first microservice 208A. The computer system 202 is configured to compare the count of requests with a threshold count of requests. In an embodiment, the threshold count for the first microservice 208A may be the maximum count of requests that the first microservice 208A can handle with the allocated set of resources. In an alternate embodiment, the threshold count may be a range for determining the minimum threshold count and the maximum threshold count. If the count of requests received for accessing the first microservice 208A is greater than the maximum threshold count, then the computer system 202 is configured to increase the number of resources in the set of resources allocated to the first microservice 208A. Also, if the count of requests received for accessing the first microservice 208A is less than the minimum threshold count, then the computer system 202 is configured to decrease the number of resources in the set of resources allocated to the first microservice 208A to save the resources and judiciously utilize the resources.

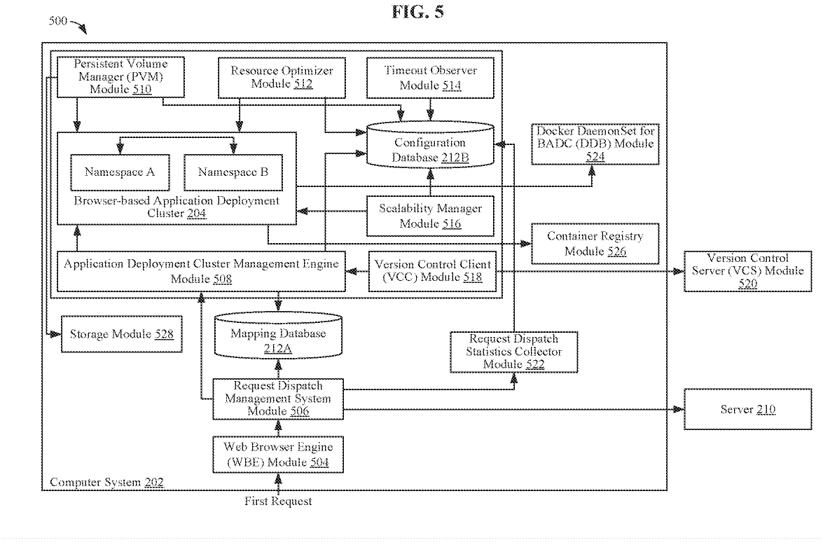

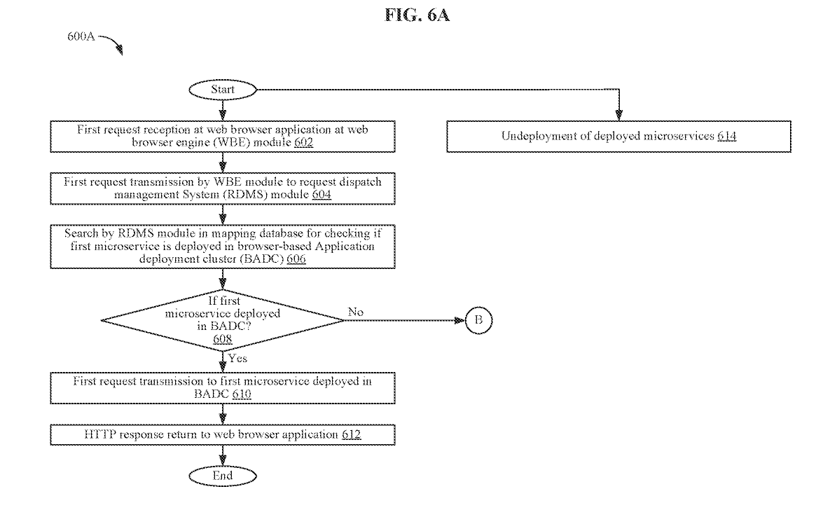

FIG. 5 is a diagram that illustrates exemplary components of a system for inter-application communication in a browser-based application deployment cluster, in accordance with various embodiments of the disclosure. FIG. 5 is explained in conjunction with elements from FIG. 1, FIG. 2, FIG. 3, and FIG. 4. With reference to FIG. 5, there is shown a diagram 500 of the computer system 202. The computer system 202 includes a Web Browser Engine (WBE) module 504, a request dispatch management system (RDMS) module 506, the mapping database 212A, an application deployment cluster management engine (ADCME) module 508, the BADC 204, the configuration database 212B, a persistent volume manager (PVM) module 510, a resource optimizer module 512, a timeout observer module 514, a scalability manager module 516, a version control client (VCC) module 518, a request dispatch statistics collector (RDSC) module 522, a docker daemon-set for BADC (DDB) module 524, a container registry module 526, and a storage module 528. The diagram 500 further includes a version control server (VCS) module 520 and the server 210.

In an embodiment of the disclosure, the WBE module 504 is a component that provides the system functionalities to the web browser application to run on the computer system 202. The WBE module 504 of the web browser application renders content on the user interface of the web browser application as per the requests received by the web browser application. Further, WBE module 504 receives the first request which may be the HTTP request made by accessing a URL on the web browser application installed on the computer system 202. This HTTP request may be received from the user 214 in possession of or operating the computer system 202, or from the second microservice 208B.

The RDMS module 506 refers to a component that is configured to dispatch requests between the microservice (say the first microservice 208A) deployed in the BADC 204, and the server 210. The RDMS module 506 is configured to receive the first request from the WBE module 504 and dispatch (or transmit) the first request either to the first microservice 208A if the first microservice 208A is deployed in the BADC 204, or to the server 210 if the first microservice 208A is not deployed in the BADC 204. Details about the dispatching (or transmission) of the request are provided, for example, in FIG. 3.

The mapping database 212A refers to a database that is configured to store data of the microservices deployed in the BADC 204 and the URLs of the applications associated with the microservices. The mapping of the microservices deployed in the BADC 204 may be stored in tabular form, etc. For example, the mapping database 212A may include a list of microservices deployed in the BADC 204, a list of identifiers of the list of microservices deployed in the BADC 204, and a list of node identifiers where each microservice is deployed in the BADC 204. In another example, the mapping database 212A may include mapping of the namespace of the first microservice 208A with the identifier of the first microservice 208A.

The ADCME module 508 is a component that is configured to interact with, operate, and manage the BADC 204 and also update the mapping database 212A with information about the microservices deployed in the BADC 204. The ADCME module 508 is an entry point for the BADC 204.

In various embodiments of the disclosure, the BADC 204 is configured to host microservices (such as the first microservice 208A, the second microservice 208B, up to the Nth microservice 208N) in namespaces specific to web applications (such as the first application, or the second application). The BADC 204 is a cluster installed as part of the web browser application on the computer system 202 which uses a DDB module 524 for running pods to deploy microservices, such as the first microservice 208A. Also, the BADC 204 hosts the microservices in namespaces (Namespace A and Namespace B, as shown). Although only 2 namespaces (e.g., Namespace A and Namespace B) are shown in FIG. 5, the disclosure encompasses any number of namespaces that may implement the features of the present disclosure.

The configuration database 212B is configured to store the configuration information about the microservices deployed in the BADC 204. The configuration database 212B is a browser-based database associated with the BADC 204. The PVM module 410 is configured to create persistent volume claims (PVCs) and map the PVCs to the storage module 528. The storage module 528 refers to any storage (such as the volatile memory 118) on the computer system 202.

The resource optimizer module 512 refers to a component that is configured to optimize memory, CPU, and/or other computing resources allocated to the BADC 204 as per defined rules. The defined rules refer to the policies that may be implemented by the application owner, or one skilled in the art, of implementing the features of the disclosure. For example, the optimization of memory and CPU may refer to minimizing RAM requirements and processing power allocated to the first microservice 208A for serving the first request. By way of example and by limitation, the pre-defined rules may indicate that the microservices may be un-deployed from the BADC 204 after a threshold deployment time (say 1 week).

The timeout observer module 514 refers to a component that is configured to un-deploy the deployed microservices in BADC 204 to free the resources of the deployed microservices after the threshold deployment time. As disclosed above in the disclosure, the threshold deployment time is the maximum time for which the first microservice 208A (or any microservice deployed in the BADC 204) can be deployed in the BADC 204. Also, the threshold deployment time may be the same or distinct for each of the microservices deployed in the BADC 204. This threshold deployment time may be a pre-configured interval of time, stored in the storage module 528. In an embodiment, the threshold deployment time may be dynamically updated based on one or more criteria (such as if the count of requests to the service is less than a threshold number of requests (anticipated requests)).

The scalability manager module 516 is a component that is configured to scale up or scale down the pods on the microservices (such as the first microservice 208A) deployed in the BADC 204 based on the statistics collected by the request dispatch statistics collector (RDSC) module 522. The RDSC module 522 is a component that is configured to collect information about the number of requests (such as the first request) transmitted to the microservices (such as the first microservice 208A) deployed in the BADC 204 and the number of requests transmitted to the server 210.

The version control client (VCC) module 518 is a component that is configured to manage versions of the deployed microservices in the BADC 204. The version control client (VCC) module 518 is configured to fetch, from the version controller server (VCS) module 520, information about the availability of new versions of the microservices (such as the first microservice 208A) that can be deployed in the BADC 204. In an embodiment, the VCC may work on a publisher-subscriber model to determine if the new versions of the microservices are available to be deployed in the BADC 204.

The VCS module 520 is a component that is configured to transmit, to the VCC module 518, the information about the availability of new versions of the microservices (such as the first microservice 208A) that are deployed in the BADC 204. The information provided by the VCS module 520 may include metadata (e.g., docker image URLs, namespaces, PVCs, and other configuration information) of the new versions of the microservices (such as the first microservice 208A) which can be upgraded in the BADC 204. The docker daemon-set for BADC (DDB) module 524 refers to a dedicated module for managing the docker runtime for the BADC 204 on the computer system 202. The container registry module 526 is a component that is configured to store docker images which would be deployed in the BADC 204.

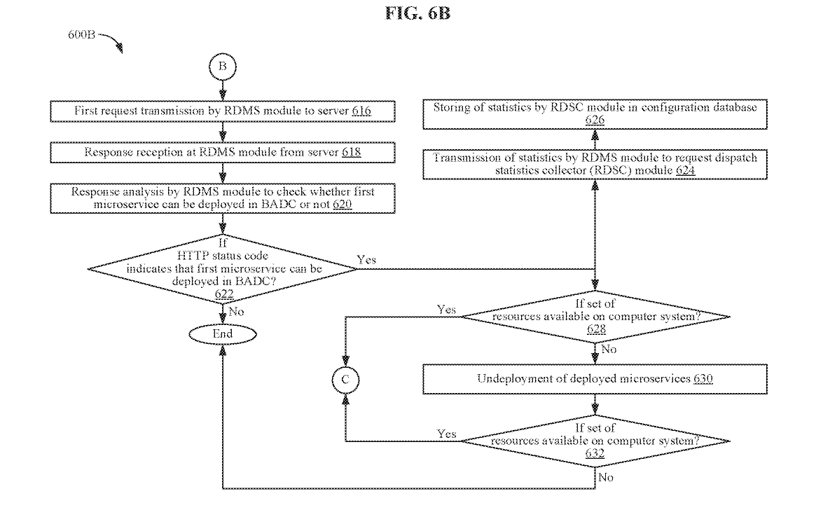

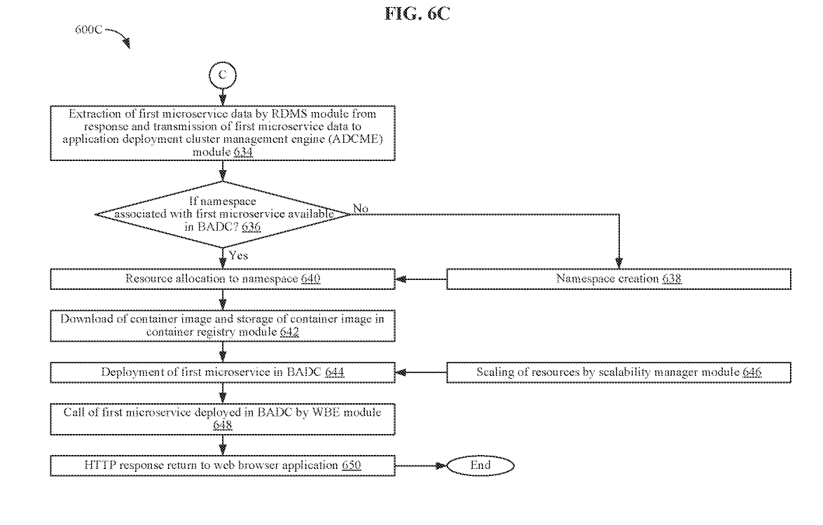

Further operations of the components shown in diagram 500 are explained with reference to FIG. 6A, FIG. 6B, and FIG. 6C. FIGS. 6A-6C are diagrams that collectively illustrate an exemplary flowchart of a method for inter-application communication in a browser-based application deployment cluster. FIG. 6A, FIG. 6B, and FIG. 6C illustrate diagrams of flowcharts 600A, 600B, and 600C respectively. The flowcharts 600A, 600B, and 600C collectively illustrates an exemplary flowchart of a method for inter-application communication in a browser-based application deployment cluster, in accordance with various embodiments of the disclosure. The flowcharts 600A, 600B, and 600C collectively illustrates exemplary operations that may start at 602 and may be performed by any computing system, apparatus, or device, such as by the computer 102 of FIG. 1 or the computer system 202 of FIG. 2. Although illustrated with discrete blocks, the exemplary operations associated with one or more blocks of the flowchart may be divided into additional blocks, combined into fewer blocks, or eliminated, depending on the particular implementation. For a clear explanation of the features of the disclosure, the FIGS. 6A-6C will be explained further in conjunction with each other. Also, the FIGS. 6A-6C are explained in conjunction with elements from FIG. 1, FIG. 2, FIG. 3, FIG. 4, and FIG. 5. In various embodiments of the disclosure, the FIGS. 6A-6C refer to various operations of larger method flow, that is, the method for inter-application communication in a browser-based application deployment cluster. In various embodiments of the disclosure, one or more operations of FIGS. 6A-6C may not be performed in the same sequence as may appear from reference numerals. In various embodiments of the disclosure, one or more operations are shown in FIGS. 6A-6C may not be performed while performing the method for inter-application communication in a browser-based application deployment cluster.

Referring to FIG. 6A, at 602, the first request is received. In an embodiment, the WBE module 504 of the web browser application is configured to receive the first request. In an embodiment, the first request is an HTTP request for accessing the first microservice 208A associated with the first application. The computer system 202 is configured to receive the first request via a user interface of the computer system 202 from the user 214 accessing the web browser application installed on the computer system 202 or from the second microservice 208B associated with the second application. In an embodiment, the first microservice 208A is associated with the first application to provide a service of one or more services that may be provided by the first application to the user 214.

At 604, the WBE module 504 of the computer system 202 is configured to transmit the first request to the RDMS module 506. The RDMS module 506 has the responsibility to dispatch the first request either to the BADC 204 of the computer system 202 or to the server 210. Thus, the RDMS module 506 is configured to decide whether to dispatch the first request to the BADC 204 or the server 210. For deciding regarding the dispatch of the first request, the RDMS module 506 is configured to search for the first microservice 208A in the mapping database 212A.

At 606, the RDMS module 506 of the computer system 202 checks whether the first microservice 208A is available in the BADC 204. For checking whether the first microservice 208A is available in the BADC 204, the RDMS module 506 is configured to check whether the URL associated with the first microservice 208A is available in the mapping database 212A or not. The URL associated with the first microservice 208A is mentioned in the first request. The checking whether the URL associated with the first microservice 208A is available in the mapping database 212A or not is performed to check if the first microservice 208A is deployed and available in the BADC 204. The RDMS module 506, upon receiving the first request, is configured to query the mapping database 212A. Further, the RDMS module 506 is configured to receive a response from the mapping database 212A based on the query transmitted to the mapping database 212A.

At 608, it is determined if the first microservice 208A is deployed in the BADC. Specifically, the RDMS module 506 is configured to determine the presence or the absence of the first microservice 208A associated with the first application in the BADC 204 associated with the web browser application. In the case at 608, the RDMS module 506 determines that the first microservice 208A is present in the BADC 204, the control transfers to 610. Otherwise, if the RDMS module 506 determines that the first microservice 208A is absent in the BADC 204, the control transfers to B as shown in FIG. 6A and further explained with reference to FIG. 6B.

At 610, the first request is transmitted to the first microservice 208A based on the determination that the first microservice 208A is deployed in the BADC 204. At 612, the RDMS module 506 of the computer system 202 returns a response to the WBE module 504 of the computer system 202 indicating the presence of the first microservice 208A in the BADC 204, and the process ends. Notably, since the first microservice 208A is deployed locally at the computer system 202 and no further processing is done to send the request to server 210, a lot of time and resources are saved.

At 614, it may be determined if deployment time of the previously deployed microservices is greater than threshold deployment time. In case the deployment time of at least one of the previously deployed microservices is greater than the threshold deployment time, then the control may be transferred to 616. Otherwise, the control may be transferred to 602.

At 616, the resource optimizer module 512 of the computer system 202 is configured to periodically un-deploy the previously deployed microservices in the BADC 204 to free the resources of the computer system 202 periodically. This periodic un-deployment of the previously deployed microservices in the BADC 204 occurs frequently after every time interval ‘T’ which may be pre-configured or dynamically updated by the computer system 202. In an embodiment, the timeout observer module 514 is configured to continuously or frequently check deployment time associated with the deployed microservices deployed in the BADC 204. For example, the deployment time for a microservice ‘X’ may be construed as the time elapsed since the microservice ‘X’ was deployed in the BADC 204. Also, the timeout observer module 514 is configured to compare the deployment time with a threshold deployment time. The threshold deployment time may be referred to as the maximum time for which the microservice ‘X’ can be deployed in the BADC 204. The threshold deployment time may be stored in the storage module 528. To compare the deployment time of the microservice ‘X’ with the threshold deployment time of the microservice ‘X’, the timeout observer module 514 is configured to monitor continuously, or frequently after a certain interval of time, the deployment time of microservice ‘X’. If the deployment time of the first microservice ‘X’ is determined equal to or greater than the threshold deployment time of the microservice ‘X’ then the resource optimizer module 512 is configured to un-deploy the microservice ‘X’ from BADC 204. Thus, the set of resources is freed due to the un-deployment of the microservice ‘X’ from the BADC 204.

Referring to FIG. 6B, at 618, the RDMS module 506 of the computer system 202 is configured to transmit the first request to the server 210 where the first microservice 208A is deployed. The transmission of the first request to the server 210 is based on the determination that the first microservice 208A is not present in the BADC 204.

In various embodiments of the disclosure, the execution of the process for deployment of the first microservice 208A at the BADC 204 is based on the count of requests received by the WBE module 504 for accessing the first microservice 208A, as included in the statistics. The RDMS module 506 of the computer system 202 may compare the count of requests with a threshold count. The threshold count for a microservice ‘A’ indicates the maximum number of requests that are received at the computer system 202 for accessing the microservice A, before deployment of the microservice ‘A’ at the BADC 204. Thus, in case the count of requests made to access the first microservice 208A is greater than the threshold count, the process for deployment of the first microservice 208A in the BADC 204 is executed by the computer system 202. Also, in various embodiments, the process for deployment of the first microservice 208A in the BADC 204 is not executed based on the comparison of the count of the received set of requests with the threshold count but is executed based on the availability of the first microservice 208A to be deployed at the BADC 204.

At 620, the RDMS module 506 is configured to receive a response from the server 210. Based on the transmission of the first request to the server 210, the computer system 202 receives a response from the server 210. The response from the server 210 may be an HTTP response and may include an HTTP status code. The HTTP status code of the received response indicates whether the first microservice 208A is available to be deployed in the BADC 204 or not.

At 622, the HTTP status code of the received response is analyzed. In an embodiment, the RDMS module 506 of the computer system 202 is configured to analyze the HTTP status code of the received response. The analysis of the response is done to check whether the first microservice 208A is available to be deployed (or hosted) in the BADC 204 or not.

At 624, it is determined whether the first microservice 208A is available to be deployed (or hosted) in the BADC 204 or not. In an embodiment, the RDMS module 506 is configured to determine whether the first microservice 208A is available to be hosted in the BADC 204 or not. The determination is based on the checking of the HTTP status code of the received response. If the RDMS module 506 of the computer system 202 determines that the first microservice 208A is not available to be hosted in the BADC 204, then the RDMS module 506 of the computer system 202 returns a response to the WBE module 504 of the computer system 202 indicating that the first microservice 208A is not available to be hosted in the BADC 204, and the process ends.

Otherwise, if the RDMS module 506 of the computer system 202 determines that the first microservice 208A is available to be hosted in the BADC 204, then in an embodiment of the disclosure, the control transfers to 626 and 630 which may be executed in parallel.

At 626, the RDMS module 506 of the computer system 202 is configured to transmit statistics about the first microservice 208A to the RDSC module 522 of the computer system 202. In an embodiment, the statistics include a count of requests received by the WBE module 504 for accessing the first microservice 208A in a given time interval. In an embodiment, the deployment of the first microservice 208A at the BADC 204 is based on the count of requests received by the WBE module 504 for accessing the first microservice 208A, as included in the statistics. The RDMS module 506 may compare the count of requests with a threshold count. The threshold count for the microservice ‘A’ indicates the maximum number of requests that are received at the computer system 202 for accessing the microservice ‘A’, before deployment of the microservice ‘A’ at the BADC 204. Thus, in case the count of requests made to access the first microservice 208A is greater than the threshold count, the process for deployment of the first microservice 208A in the BADC 204 is executed by the computer system 202.

At 628, the RDSC module 522 is configured to store the statistics in the configuration database 212B. At 630, the availability of a set of resources to deploy the first microservice 208A is checked. In an embodiment, the RDMS module 506 is configured to determine whether the set of resources to deploy the first microservice 208A is available on the computer system 202 locally or not. If the RDMS module 506 determines that the set of resources to deploy the first microservice 208A is available on the computer system 202 locally, then the flow moves to C as shown in FIG. 6B and further explained with reference to FIG. 6C. Otherwise, if the RDMS module 506 of the computer system 202 determines that the set of resources to deploy the first microservice 208A is not available on the computer system 202 locally, then the flow moves to 632.

At 632, the resource optimizer module 512 of the computer system 202 is configured to un-deploy the previously deployed microservices to free the resources of the computer system 202. The resources may be undeployed based on pre-configured rules. For example, the microservices that have been deployed for a time period greater than a pre-defined threshold deployment time period may be undeployed. The un-deployment of previously deployed resources is done to free the resources so that the resources can be allocated for performing other operations, such as, for deployment of the first microservice 208A in the BADC 204.

At 634, after the un-deployment of the previously deployed microservices, the availability of the set of resources to deploy the first microservice 208A is checked. In an embodiment, the RDMS module 506 of the computer system 202 is configured to determine whether the set of resources to deploy the first microservice 208A is available on the computer system 202 locally or not. If the RDMS module 506 of the computer system 202 determines that the set of resources to deploy the first microservice 208A is available on the computer system 202 locally, then the flow moves to C as shown in FIG. 6B and further explained with reference to FIG. 6C. Otherwise, if the RDMS module 506 determines that the set of resources to deploy the first microservice 208A is not available on the computer system 202 locally, then the RDMS module 506 is configured to transmit a response to the WBE module indicating the absence of the set of resources to deploy the first microservice 208A in the BADC 204 and the process ends.

Referring to FIG. 6C, at 636, the first microservice data is extracted. In an embodiment, the RDMS module 506 is configured to extract the first microservice data from the response transmitted by the server 210. The RDMS module 506 is configured to transmit the first microservice data to the ADCME module 508. In various embodiments of the disclosure, the first microservice data includes a header information of the response received from the server 210.

At 638, it is determined if a namespace for the first microservice 208A is available in the BADC 204. In an embodiment of the disclosure, the ADCME module 508 is configured to determine whether a namespace for the first microservice 208A is available in the BADC 204 or not. In an embodiment, the ADCME module 508 is configured to determine whether a namespace that is the same as (or equal to) the domain of the URL of the first application (with which the first microservice 208A is associated) is available or not. The ADCME module 508 also has information about the deployed microservices at the BADC 204 as the ADCME module 508 interacts with the mapping database 212A for information about the microservices deployed in the BADC 204 and updates the mapping database 212A. If the ADCME module 508 determines that the namespace for the first microservice 208A is available in the BADC 204, then the control transfers to 642. Otherwise, if the ADCME module 508 determines that the namespace for the first microservice 208A is not available in the BADC 204, then the control transfers to 640.

At 640, the namespace for the first microservice 208A is created. In an embodiment, the ADCME module 508 is configured to create the namespace for the first microservice 208A based on the determination that the namespace for the first microservice 208A is not available in the BADC 204. The namespace for the first microservice 208A is equal to the domain of the first application with which the first microservice 208A is associated.

At 642, the set of resources is allocated to the namespace for the first microservice 208A. In an embodiment, the ADCME module 508 of the computer system 202 is configured to allocate the set of resources for deployment of the first microservice 208A in the BADC 204. The set of resources includes, but is not limited to, computing resources, memory resources, networking resources, storage resources, etc. of the computer system 202.

At 644, the container image of the first microservice 208A is downloaded. In an embodiment, the ADCME module 508 of the computer system 202 is configured to download the container image of the first microservice 208A using the first microservice data. The first microservice data may contain the URL using which the ADCME module 508 may download the container image of the first microservice 208A. The ADCME module 508 is further configured to store the downloaded container image of the first microservice 208A in the container registry module 526.

At 646, the first microservice 208A is deployed in the BADC 204. In an embodiment, the ADCME module 508 is configured to deploy the container image of the first microservice 208A in the namespace in the BADC 204. In an embodiment of the disclosure, the ADCME module 508 is configured to store the mapping of the namespace and the identifier of the first microservice 208A in the mapping database 212A, based on the deployment of the first microservice 208A in the namespace in the BADC 204.

In various embodiments of the disclosure, for deploying the first microservice 208A, the set of resources of the BADC 204 allocated to the namespace for the first microservice 208A is used. The set of resources includes, but is not limited to, pods (which host the docker containers as mentioned in the first microservice data) are allocated according to the data of the URL of the container image which needs to be deployed in BADC 204 to host the first microservice 208A, persistent volume which utilizes the storage space of the computer system 202 is allocated according to persistent volume claims that are allocated according to the data related to persistent volume claims (PVC) for the pod for hosting the first microservice 208A, secrets (which contain configuration information encoded as base64 as key-value pairs as mentioned in the first microservice data are allocated according to the data related to secrets for the pod, ConfigMaps (which contain configuration information as key-value pairs as mentioned in the first microservice data) are allocated according to the data related to ConfigMap for the pod, etc.

At 648, the scalability manager module 516 is configured to scale the set of resources as per the data traffic on the first microservice 208A. For example, if the number of requests received by the first microservice 208A is higher than, for example, a threshold number of requests, then the scalability manager module 516 may increase the amount of resources allocated to the first microservice 208A, and vice versa. For this purpose, the threshold number of requests may be stored in the storage module 528.

At 650, the first microservice 208A deployed in the BADC 204 may be accessed. In an embodiment, the WBE module 504 is configured to access the first microservice 208A deployed in the BADC 204 according to the request received at the WBE module 504 for accessing the first microservice 208A. Now since the first microservice 208A is deployed in the BADC 204, the first microservice 208A can be accessed directly at the computer system 202 without transmitting the request to the server 210. Also, in various embodiments of the disclosure, where the request to access the first microservice 208A is received from the second microservice 208B that is already deployed in the BADC 204, the RDMS module 506 is configured to transmit the first request to the first microservice 208A deployed in the BADC 204. For example, say there is a browser-based container C1 associated with the first microservice 208A in the BADC 204 and a browser-based container C2 associated with the second microservice 208B in the BADC 204. The web browser application can chain requests from C1 and C2. So, the first request from the second microservice 208B is communicated to the first microservice 208A without transmitting to the server 210.

All this communication takes place at the edge of the components internal to the computer system 202, and therefore a lot of resources and time is saved (reducing latency) in the communication as compared to the traditional methods where the request would be transmitted to the server 210 where the microservice is deployed.

At 652, a response is returned to the WBE module 504. In an embodiment, the RDMS module 506 is configured to return a response (to the received request from the WBE module 504) to the WBE module 504.

In an embodiment, the resource optimizer module 512 is configured to modify the set of resources allocated to the first microservice 208A based on a count of requests received at the WBE module 504 for accessing the first microservice 208A. The resource optimizer module 512 is configured to compare the count of requests with a threshold count of requests. In an embodiment, the threshold count for the first microservice 208A is the maximum count of requests that the first microservice 208A can manage with the allocated set of resources. In various embodiment, the threshold count may be a range for determining the minimum threshold count and the maximum threshold count. If the count of requests received for accessing the first microservice 208A is greater than the maximum threshold count, then the resource optimizer module 512 is configured to increase the number of resources in the set of resources allocated to the first microservice 208A. Also, if the count of requests received for accessing the first microservice 208A is less than the minimum threshold count, then the resource optimizer module 512 is configured to decrease the number of resources in the set of resources allocated to the first microservice 208A to save the resources and judiciously utilize the resources.

In an embodiment of the disclosure, the VCC module 518 is configured to determine the first version of the first microservice 208A associated with the first application. The first version may be a current version of the first microservice 208A deployed in the BADC 204. Further, the VCC module 518 is configured to check if a second version for the first microservice 208A is available to be installed. The second version may be a latest version of the first microservice 208A, or an older version of the first microservice 208A that can be installed as the first microservice 208A. In various embodiments, the VCC module 518 is configured to retrieve a second microservice data associated with the second version of the first microservice 208A from the VCS module 520. The second microservice data includes files, dependencies, etc. to be installed while installing the second version of the first microservice 208A.

To optimize the utilization of the computing resources on the user device, various applicable configurations include, but are not limited to, configuring a maximum number of browser-based application deployment clusters, namespaces, and sets of resources in each cluster and namespace. The oldest cluster, namespace, and the set of resources inside the namespace may be deleted if the maximum number of allowed namespaces is exceeded. The applicable configurations include further include whitelisting or blacklisting of applications based on whether the applications are allowed to get deployed in the browser-based application deployment cluster. The applicable configurations further include the application of a limit on the set of resources that can be allocated (CPU, Memory, Disk, Bandwidth, etc.) to a namespace. The applicable configurations further include specifying a timeout for namespaces and a set of resources after which the namespace may be deleted or the resources of the computer may be set free. The namespaces and the set of resources may also be marked as removable or non-removable. Removable namespaces or set of resources could be deleted from the browser-based application deployment cluster before the timeout duration of the namespace ends, while the non-removable namespaces could be deleted only after the timeout duration of the namespace. The metadata of the HTTP response header may contain information about the microservice to be deployed in the browser-based application deployment cluster. The information about the microservice may include the number of pods needed per N number of concurrent requests, where the information may be stored in the configuration database. The scalability manager module may increase or decrease the number of pods based on the information about the microservice.

Further, various applicable security and permissions configurations include, but are not limited to, disabling the login into the pods or containers installed in the browser-based application deployment cluster, limiting the accessibility of a pod for an application from the namespace of the application and not the namespace of another application, allowing or restricting the deployment of containers in a cluster that deploy containers of applications that are blacklisted in the same cluster, allowing or restricting specific operations, such as PVC creation, secrets creation, etc. for different namespaces.

Further, various utilities of maintaining clusters in the computer may include, but are not limited to, a function of creation of and deletion of browser-based application deployment cluster, mapping of the domain name of the application to a cluster and namespace, function of configuring resource utilization parameters e.g., resource limits, etc. for clusters, namespaces, and applications, mark namespaces as removable or non-removable, etc.

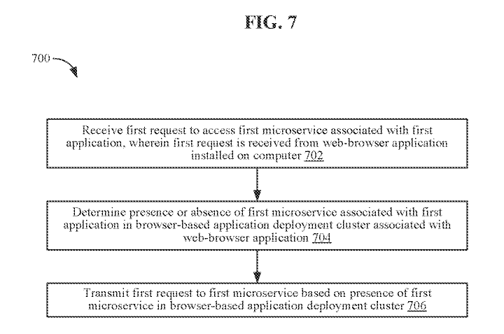

FIG. 7 is a diagram that illustrates a flowchart for routing a request for accessing a microservice, in accordance with various embodiments of the disclosure. FIG. 7 is explained in conjunction with elements from FIG. 1, FIG. 2, FIG. 3, FIG. 4, FIG. 5, FIG. 6A, FIG. 6B, and FIG. 6C. With reference to FIG. 7, there is shown a flowchart 700 that illustrates exemplary operations from 702 to 706, as described herein. The operations of the flowchart 700 may be executed by any computing system, for example, by the computer 102 of FIG. 1 or the computer system 202 of FIG. 2. The operations of the flowchart 700 may start at 702.

At 702, the first request for accessing the first microservice 208A associated with the first application is received. The first request is received via the web browser application installed on the computer system 202. In an embodiment, the computer system 202 is configured to receive the first request to access a first microservice associated with a first application, wherein the first request is received from a web-browser application installed on the computer system 202. Details about the reception of the first request are provided, for example, in FIG. 3.

At 704, a presence or an absence of the first microservice associated with the first application in the BADC 204 associated with the web-browser application may be determined. The presence or absence of the first microservice is determined based on the first request. In an embodiment, the computer system 202 is configured to determine the presence or the absence of the first microservice associated with the first application in the BADC 204 associated with the web-browser application, wherein the presence or the absence of the first microservice is determined based on the first request. Details about the determination of the presence or the absence of the first microservice are provided, for example, in FIG. 3.

At 706, the first request is transmitted to the first microservice 208A based on the determination that the first microservice 208A is present in the BADC 204. In an embodiment, the computer system 202 is configured to transmit the first request to the first microservice based on the presence of the first microservice in the BADC 204. Details about the transmission of the first request are provided, for example, in FIG. 3, FIG. 5, FIG. 6A, FIG. 6B and FIG. 6C.

While the above operations shown in FIG. 7 are described in a particular sequence, the operations may occur in variations to the sequence in accordance with various embodiments of the present disclosure. Further, details related to various operations of FIG. 7 which are already covered in the description related to FIG. 1, FIG. 2, FIG. 3, FIG. 4, FIG. 5, FIG. 6A, FIG. 6B and FIG. 6C is not discussed again in detail here for the sake of brevity.

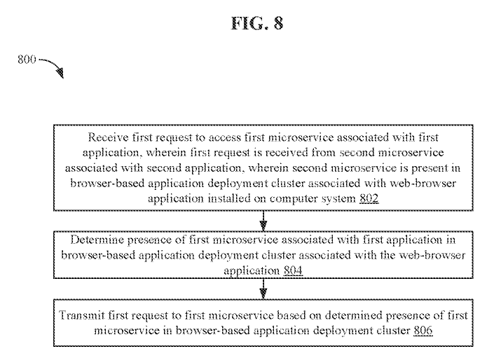

FIG. 8 is a diagram that illustrates a flowchart 800 of a method for inter-application communication in a browser-based application deployment cluster, in accordance with various embodiments of the disclosure. FIG. 8 is explained in conjunction with elements from FIG. 1, FIG. 2, FIG. 3, FIG. 4, FIG. 5, FIG. 6A, FIG. 6B, FIG. 6C, and FIG. 7. With reference to FIG. 8, there is shown a flowchart 800 that illustrates exemplary operations from 802 to 806, as described herein. The operations of the method depicted by the flowchart 800 may be executed by any computing system, for example, by the computer 102 of FIG. 1 or the computer system 202 of FIG. 2. The operations of the flowchart 800 may start at 802.

At 802, the first request to access the first microservice 208A associated with the first application is received. The first request is received from the second microservice 208B associated with the second application. The second microservice is present in the BADC 204 associated with the web-browser application installed on the computer system 202. In an embodiment, the computer system 202 is configured to receive the first request to access the first microservice associated with the first application, wherein the first request is received from the second microservice 208B associated with the second application, wherein the second microservice 208B is present in a browser-based application deployment cluster associated with a web-browser application on the computer system.

At 804, the presence of the first microservice 208A associated with the first application in the browser-based application deployment cluster associated with the web-browser application in the BADC 204 is determined. The presence of the first microservice 208A is determined based on the received first request. In an embodiment, the computer system 202 is configured to determine the presence of the first microservice associated with the first application in the BADC 204 associated with the web-browser application, wherein the presence of the first microservice 208A is determined based on the received first request. Details about the determination of the presence or the absence of the first microservice are provided, for example, in FIG. 3.

At 806, the first request is transmitted to the first microservice 208A based on the determined presence of the first microservice in the BADC 204. In an embodiment, the computer system 202 is configured to transmit the first request to the first microservice 208A based on determination of the presence of the first microservice 208A in the BADC 204. Details about the transmission of the first request are provided, for example, in FIG. 3, FIG. 5, FIG. 6A, FIG. 6B and FIG. 6C.

While the above operations shown in FIG. 8 are described in a particular sequence, the operations may occur in variations to the sequence in accordance with various embodiments of the present disclosure. Further, details related to various operations of FIG. 8 which are already covered in the description related to FIG. 1, FIG. 2, FIG. 3, FIG. 4, FIG. 5, FIG. 6A, FIG. 6B, FIG. 6C, and FIG. 7 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first request to access a first microservice associated with a first application, wherein the first request is received from a web-browser application installed on the computer;
determining, by the computer, a presence or an absence of the first microservice associated with the first application in a browser-based application deployment cluster associated with the web-browser application, wherein the presence or the absence of the first microservice is determined based on the first request; and
transmitting, by the computer, the first request to the first microservice based on the presence of the first microservice in the browser-based application deployment cluster.

2. The computer-implemented method of claim 1, further comprising:
determining, by the computer, the absence of the first microservice in the browser-based application deployment cluster; and
transmitting, by the computer, the first request to a server based on the absence of the first microservice in the browser-based application deployment cluster, wherein the first application is hosted on the server.

3. The computer-implemented method of claim 2, further comprising:
receiving, by the computer, a response from the server based on the transmission of the first request to the server, the response indicative of a deployment of at least the first microservice in the browser-based application deployment cluster; and
retrieving, by the computer, first microservice data associated with at least the first microservice based on the response.

4. The computer-implemented method of claim 3, further comprising:
determining, by the computer, an availability of a set of resources of the computer based on the first microservice data; and
creating, by the computer, a namespace for the first microservice in the browser-based application deployment cluster based on the determination of the availability of the set of resources of the computer, wherein the set of resources of the computer is allocated to the created namespace.

5. The computer-implemented method of claim 4, further comprising:
deploying, by the computer, the first microservice in the browser-based application deployment cluster based on the created namespace and the first microservice data; and
storing, by the computer, a mapping of the namespace and an identifier associated with the first microservice in a mapping database.

6. The computer-implemented method of claim 3, further comprising:
determining, by the computer, an unavailability of a set of resources of the computer based on the first microservice data; and
transmitting, by the computer, the first request to the server based on the determination of the unavailability of the set of resources of the computer.

7. The computer-implemented method of claim 1, further comprising:
receiving, by the computer, a second request to access a second microservice associated with a second application, wherein the second request is received from the first microservice of the first application, and wherein the second microservice is deployed in the browser-based application deployment cluster; and
transmitting, by the computer, the second request to the second microservice based on the reception of the second request.

8. The computer-implemented method of claim 1, further comprising:
receiving, by the computer, a set of requests for accessing the first microservice deployed in the browser-based application deployment cluster, wherein the set of requests comprises the first request;
determining, by the computer, a count of the received set of requests;
comparing, by the computer, the count with a threshold count; and
modifying, by the computer, a set of resources of the computer, based on the comparison of the count with the threshold count, wherein the set of resources is associated with the first microservice.

9. The computer-implemented method of claim 8, further comprising:
determining, by the computer, a deployment time associated with the first microservice;
comparing, by the computer, the deployment time with a threshold deployment time; and
modifying, by the computer, the set of resources of the computer, based on the comparison of the deployment time with the threshold deployment time, wherein the set of resources is associated with the first microservice.

10. The computer-implemented method of claim 1, further comprising:
determining, by the computer, a first version of the first microservice associated with the first application;
determining, by the computer, an availability of a second version of the first microservice based on the determined first version;
retrieving, by the computer, second microservice data associated with the second version of the first microservice; and
deploying, by the computer, the second version of the first microservice in the browser-based application deployment cluster based on the retrieved second microservice data.

11. The computer-implemented method of claim 1, further comprising:
querying, by the computer, a mapping database for the presence or the absence of the first microservice in the browser-based application deployment cluster based on the first request;
receiving, by the computer, a response based on the querying of the mapping database; and
determining, by the computer, the presence or the absence of the first microservice in the browser-based application deployment cluster based on the response.

12. A computer system, comprising:
a processor set;
one or more computer-readable storage media; and
program instructions stored on the one or more computer-readable storage media, the program instructions executable by the processor set to cause the processor set to:
receive a first request to access a first microservice associated with a first application, wherein the first request is received from a second microservice associated with a second application, wherein the second microservice is present in a browser-based application deployment cluster associated with a web-browser application installed on the computer system;
determine a presence of the first microservice associated with the first application in the browser-based application deployment cluster associated with the web-browser application, wherein the presence of the first microservice is determined based on the received first request; and
transmit the first request to the first microservice based on the determined presence of the first microservice in the browser-based application deployment cluster.

13. The computer system of claim 12, wherein the program instructions further cause the processor set to:
receive a set of requests to access the first microservice deployed in the browser-based application deployment cluster, wherein the set of requests comprises the first request;
determine a count of the received set of requests;
compare the count with a threshold count; and
modify a set of resources of the computer system, based on the comparison of the count with the threshold count, wherein the set of resources is associated with the first microservice.

14. The computer system of claim 12, wherein the program instructions further cause the processor set to:
determine a deployment time associated with the first microservice;
compare the deployment time with a threshold deployment time; and
modify a set of resources of the computer system, based on the comparison of the deployment time with the threshold deployment time, wherein the set of resources is associated with the first microservice.

15. The computer system of claim 12, wherein the program instructions further cause the processor set to:
determine a first version of the first microservice associated with the first application;
determine an availability of a second version of the first microservice based on the determined first version;
retrieve second microservice data associated with the second version of the first microservice; and
deploy the second version of the first microservice in the browser-based application deployment cluster based on the retrieved second microservice data.

16. A computer program product for transmitting a request for accessing a microservice deployed in a browser-based application deployment cluster, the computer program product comprising:
one or more computer-readable storage media; and
program instructions stored on the one or more computer-readable storage media to perform operations comprising:
receiving the request to access the microservice associated with an application, the request received from a web-browser application;
determining a presence or an absence of the microservice associated with the application in the browser-based application deployment cluster associated with the web-browser application, wherein the presence of the microservice is determined based on the request; and
transmitting the request to the microservice based on the presence of the microservice in the browser-based application deployment cluster.

17. The computer program product of claim 16, wherein the. program instructions stored on the one or more computer-readable storage media perform the operations further comprising:
determining the absence of the microservice in the browser-based application deployment cluster; and
transmitting the request to a server based on the determined absence of the microservice in the browser-based application deployment cluster, wherein the application is hosted on the server.

18. The computer program product of claim 17, wherein the program instructions stored on the one or more computer-readable storage media perform the operations further comprising:
receiving a response from the server based on the transmission of the request to the server, the response indicative of a deployment of at least the microservice in the browser-based application deployment cluster; and
retrieving microservice data associated with at least the microservice based on the response.

19. The computer program product of claim 18, wherein the program instructions stored on the one or more computer-readable storage media perform the operations further comprising:
determining an availability of a set of resources of a computer associated with the computer program product, based on the microservice data, wherein the operations are performed by the computer; and
creating a namespace for the microservice in the browser-based application deployment cluster based on the determination of the availability of the set of resources of the computer, wherein the set of resources of the computer is allocated to the created namespace.

20. The computer program product of claim 19, wherein the program instructions stored on the one or more computer-readable storage media perform the operations further comprising:
deploying the microservice in the browser-based application deployment cluster based on the created namespace and the microservice data; and
storing a mapping of the namespace and an identifier associated with the microservice in a mapping database.
